(19) United States
(12) Patent Application Publication
(10) Pub. No.: US 2022/0085370 A1
(43) Pub. Date: Mar. 17, 2022

(54) NEGATIVE ELECTRODE MATERIAL FOR LITHIUM ION SECONDARY BATTERY, METHOD OF PRODUCING NEGATIVE ELECTRODE MATERIAL FOR LITHIUM ION SECONDARY BATTERY, NEGATIVE ELECTRODE FOR LITHIUM ION SECONDARY BATTERY, AND LITHIUM ION SECONDARY BATTERY

(71) Applicant: SHOWA DENKO MATERIALS CO., LTD., Chiyoda-ku, Tokyo (JP)

(72) Inventors: Kento HOSHI, Chiyoda-ku, Tokyo (JP); Wakana OKAMURA, Chiyoda-ku, Tokyo (JP); Takashi KUBOTA, Chiyoda-ku, Tokyo (JP)

(21) Appl. No.: 17/420,143

(22) PCT Filed: Dec. 27, 2019
(86) PCT No.: PCT/JP2019/051577

§ 371 Date: Jul. 1, 2021

(30) Foreign Application Priority Data
Jan. 4, 2019 (JP) PCT/JP2019/000035

(51) Int. Cl. H01M 4/583; H01M 10/0525

(52) U.S. Cl. CPC H01M 4/583; H01M 2004/027; H01M 10/0525

(57) ABSTRACT

A negative electrode active material for a lithium ion secondary battery includes carbonaceous particles having a BET specific surface area of water vapor adsorption of 0.095 m²/g or less calculated from an amount of water vapor adsorption at a relative pressure of from 0.05 to 0.12.

### TECHNICAL FIELD

The present invention relates to a negative electrode material for a lithium ion secondary battery, a method of producing the negative electrode material for a lithium ion secondary battery, a negative electrode for a lithium ion secondary battery, and a lithium ion secondary battery.

### BACKGROUND ART

Lithium ion secondary batteries have been conventionally and widely used in electronic devices, such as notebook PCs, mobile phones, smartphones, and Tablet PCs, taking advantage of being compact and lightweight, as well as having a high energy density. With growing concerns about environmental issues such as global warming due to CO₂ emissions, in recent years, clean electric vehicles (EVs) which run solely on batteries, hybrid electric vehicles (HEVs) and plug-in hybrid electric vehicles (PHEVs) in which gasoline engines and batteries are combined, and the like are gaining popularity, lithium ion secondary batteries are used as on-board batteries for EVs, HEVs, PHEVs and the like. Lithium ion secondary batteries are now also used for electric power storage, and their applications are expanding into various fields.

The performance of negative electrode materials in lithium ion secondary batteries has great impact on input characteristics of the batteries. As materials for negative electrode materials for lithium ion secondary batteries, carbon materials are widely used. Carbon materials used for negative electrode materials are broadly divided into graphite, and carbon materials (amorphous carbon or the like) having a lower crystallinity than a crystallinity of graphite. Graphite has a structure in which hexagonal network planes composed of carbon atoms are regularly layered one on another, and in a case of being used for a negative electrode material in a lithium ion secondary battery, intercalation and deintercalation of lithium ions take place at the edges of the hexagonal network planes, to perform charging and discharging.

Amorphous carbon has a structure in which hexagonal network planes are irregularly layered, or do not have a hexagonal network plane. Accordingly, in a negative electrode material using amorphous carbon, the intercalation and deintercalation of lithium ions take place over an entire surface of the negative electrode material. Therefore, a lithium ion battery having excellent output characteristics tends to be obtained, as compared to the case of using graphite for a negative electrode material (see, for example, Patent Document 1 and Patent Document 2). However, since amorphous carbon has a crystallinity lower than the crystallinity of graphite, the amorphous carbon has a lower energy density than that of graphite.

Further, in Patent Document 3, graphite particles are surface-coated at least partially with amorphous carbon, and a CO₂ adsorption amount thereof is adjusted to 0.24 to 0.36 cc/g. It is described that when amorphous carbon is provided on the surface of graphite particles, it acts to increase the reaction points for the occlusion and release of lithium ions, and the charge acceptability of the graphite particles is improved. It is also described that by setting the amount of CO₂ adsorbed within the above range, a non-aqueous electrolyte secondary battery having excellent initial efficiency in addition to charge acceptability can be obtained.

### RELATED ART DOCUMENTS

### Patent Documents

Patent Document 1: Japanese Patent Application Laid-Open (JP-A) No. H04-370662

Patent Document 2: JP-A No. H05-307956

Patent Document 2: International Publications No. WO 2012/090728

### SUMMARY OF INVENTION

In on-board lithium ion secondary batteries for EVs, HEVs, PHEVs, and the like, there is a demand for a negative electrode material capable of further improving input characteristics related to regeneration efficiency, rapid charging, and the like. In addition, on-board lithium ion secondary batteries are also required to have high temperature storage characteristics. However, it has been difficult to achieve both input characteristics and high temperature storage characteristics at a higher level. In general, when the specific surface area of the negative electrode material is increased in order to improve the input characteristics, the high temperature storage characteristics tend to deteriorate. Meanwhile, when the specific surface area of the negative electrode material is reduced in order to improve the high temperature storage characteristics, the input characteristics tend to deteriorate. As described above, the input characteristics and the high temperature storage characteristics are generally in a trade-off relationship.

Further, as described in Patent Document 3, conventionally, the surface of graphite particles in contact with an electrolyte solution is covered with amorphous carbon to prevent decomposition of the electrolyte solution, and as a result, the initial charge-discharge efficiencies are prevented from lowering. However, covering with amorphous carbon tends to reduce charging characteristics (that is, input characteristics). As described above, the initial charge-discharge efficiencies and the input characteristics are generally in a trade-off relationship.

In view of the above described problems, an object of the invention is to provide a negative electrode material for a lithium ion secondary battery, a method of producing the negative electrode material for a lithium ion secondary battery, a negative electrode for a lithium ion secondary battery, and a lithium ion secondary battery, which are excellent in input characteristics, maintaining high temperature storage characteristics and initial charge-discharge efficiencies.

### Solution to Problem

The inventions include the following embodiments.

<1> A negative electrode material for a lithium ion secondary battery, the negative electrode material comprising carbonaceous particles having a BET specific surface area of water vapor adsorption of 0.095 m²/g or less calculated from an amount of water vapor adsorption at a relative pressure of from 0.05 to 0.12.

<2> The negative electrode material for a lithium ion secondary battery according to <1>, in which, in the carbonaceous particles, a ratio of the BET specific surface area of water vapor adsorption to a BET specific surface area of nitrogen adsorption calculated from an amount of nitrogen adsorption at a relative pressure of 0.3 is 0.035 or less.

<3> The negative electrode material for a lithium ion secondary battery according to <1> or <2>, in which the carbonaceous particles have a carbonaceous substance B on at least a part of a surface of a carbonaceous substance A, and the carbonaceous substance B has a lower crystallinity than the carbonaceous substance A.

<4> The negative electrode material for a lithium ion secondary battery according to <3>, in which an average thickness of the carbonaceous substance B is 1 nm or more.

<5> The negative electrode material for a lithium ion secondary battery according to <3> or <4>, in which a content of the carbonaceous substance B is 30% by mass or less with respect to a total amount of the carbonaceous particles.

<6> The negative electrode material for a lithium ion secondary battery according to any one of <1> to <5>, in which a volume average particle size of the carbonaceous particles is from 2 μm to 50 μm.

<7> The negative electrode material for a lithium ion secondary battery according to any one of <1> to <6>, in which an R value of Raman spectrometry is 0.30 or less.

<8> A method of producing the negative electrode material for a lithium ion secondary battery according to any one of <1> to <7>, the method including:

preparing activated carbonaceous substance particles A obtained by heat-treating particles of a carbonaceous substance A;

mixing a carbonaceous substance precursor that is a source of a carbonaceous substance B having a lower crystallinity than the carbonaceous substance A, and the activated carbonaceous substance particles A, to obtain a mixture; and

heat-treating the mixture, thereby obtaining carbonaceous particles.

<9> A negative electrode for a lithium ion secondary battery, the negative electrode including:

a negative electrode material layer containing the negative electrode material for a lithium ion secondary battery according to any one of <1> to <7>; and

a current collector.

<10> A lithium ion secondary battery, including:

the negative electrode for a lithium ion secondary battery according to <9>;

a positive electrode; and

an electrolyte solution.

### Advantageous Effects of Invention

According to the invention, a negative electrode material for a lithium ion secondary battery, a method of producing the negative electrode material for a lithium ion secondary battery, a negative electrode for a lithium ion secondary battery, and a lithium ion secondary battery are provided, which are excellent in input characteristics, maintaining high temperature storage characteristics and initial charge-discharge efficiencies.

### DESCRIPTION OF EMBODIMENTS

Embodiments of the invention will now be described in detail. It is to be noted, however, that the invention is not limited to the following embodiments. In the embodiments described below, components thereof (including element steps and the like) are not essential, unless otherwise specified. The same applies for numerical values and ranges thereof, and the invention is not limited thereto.

In the disclosure, any numerical range indicated using an expression “to” includes numerical values described before and after “to” as a minimum value and a maximum value, respectively.

In a numerical range described in stepwise, in the disclosure, the upper limit value or the lower limit value described in one numerical range may be replaced with the upper limit value or the lower limit value in another numerical range described in stepwise. Further, in a numerical range described in the disclosure, the upper limit value or the lower limit value described in the numerical range may be replaced with a value shown in Examples.

In the disclosure, each component may include plural kinds of substances corresponding to the component. In a case in which plural kinds of substances exist corresponding to a component in the composition, the content means, unless otherwise specified, a total amount of the plural kinds of substances existing in the composition.

In the disclosures, each component may include plural kinds of particles corresponding to the component. In a case in which plural kinds of particles exist corresponding to a component in the composition, the particle diameter means, unless otherwise specified, a value with respect to the mixture of the plural kinds of particles existing in the composition.

In the disclosure, the term “layer” comprehends herein not only a case in which the layer is formed over the whole observed region where the layer is present, but also a case in which the layer is formed only on part of the region.

In the disclosure, the term “layered” as used herein indicates that plural layers are piled up, in which two or more layers may be bonded to each other or detachable from each other.

In the present disclosure, the term “process” includes not only a process which is independent from another process, but also a process which is not clearly distinguishable from another process, as long as a purpose of the process can be achieved.

<Negative electrode Material for Lithium Ion Secondary Battery>

The negative electrode material for a lithium ion secondary battery in the disclosure includes carbonaceous particles having a BET specific surface area of water vapor adsorption of 0.095 m²/g or less calculated from an amount of water vapor adsorption at a relative pressure of from 0.05 to 0.12. The negative electrode material for a lithium ion secondary battery may contain other components, if necessary.

In the disclosure, the term “carbonaceous particles” refer to particles having a carbon content of more than 50% by mass, and the carbon content may be 70% by mass or more, 80% by mass or more, 90% by mass or more, 95% by mass or more, or 99% by mass or more.

Further, the crystallinity of “carbonaceous particles” is not limited, and carbonaceous particles may be of graphite or amorphous carbon.

By using the negative electrode material for a lithium ion secondary battery in the disclosure, it is possible to obtain a lithium ion secondary battery having excellent input characteristics while maintaining high temperature storage characteristics and initial charge-discharge efficiencies.

In the disclosure, the specific surface area of water vapor adsorption refers to a value calculated by the following method according to JIS Z 8830: 2013.

An amount of water vapor adsorption was measured when the adsorption temperature was determined to 298 K and the relative pressure P/P₀ was varied in a constant temperature bath set at 50° C. using saturated steam gas as adsorption gas with a vapor adsorption analyzer (for example, a “high-precision gas/vapor adsorption analyzer BELSORP MAX,” BEL JAPAN, INC.). The specific surface area is determined according to the BET multipoint method from the amount of water vapor adsorption when the relative pressure P/P₀ was in a range of from 0.05 to 0.12. Here, the “relative pressure P/P₀” is a value obtained by dividing the equilibrium pressure (P) by the saturated vapor pressure (P₀). Further, the automatic calculation software of the measurement apparatus may be used for calculating the specific surface area.

When measuring the BET specific surface area, it is considered that the water adsorbed on the sample surface and in the structure affects the gas adsorption capacity. Therefore, it is preferable to first remove the water by heating as a pretreatment.

In the pretreatment, for example, a measurement cell charged with 0.05 g of a measurement sample is decompressed to 10 Pa or less with a vacuum pump, heated at 110° C., retained for 3 hours or more, and then is naturally cooled to room temperature (25° C.) while being kept in a decompressed state.

The specific surface area of water vapor adsorption of carbonaceous particles is 0.095 m²/g or less, preferably 0.090 m²/g or less, and more preferably 0.080 m²/g or less.

The specific surface area of water vapor adsorption of carbonaceous particles is preferably 0.060 m²/g or more, more preferably 0.065 m²/g or more, and more preferably 0.070 m²/g or more from the practical viewpoint as a negative electrode material for a lithium ion secondary battery.

In carbonaceous particles, a BET specific surface area of nitrogen adsorption calculated from an amount of nitrogen adsorption at a relative pressure of 0.3 is preferably 2.0 m²/g or more, more preferably 2.5 m²/g or more, and still more preferably 3.0 m²/g or more from the practical viewpoint as a negative electrode material for a lithium ion secondary battery.

The specific surface area of nitrogen adsorption of carbonaceous particles is preferably 10.0 m²/g or less, more preferably 8.0 m²/g or less, and still more preferably 6.0 m²/g or less.

In the disclosure, the specific surface area of nitrogen adsorption refers to a value calculated by the following method according to JIS Z 8830: 2013. Similarly, when measuring the specific surface area of nitrogen adsorption, it is preferable to perform the pretreatment described in the measurement of the specific surface area of water vapor adsorption.

The amount of nitrogen adsorption is measured when varying the relative pressure P/P₀ at a liquid nitrogen temperature (77K) using a mixed gas of nitrogen and helium (nitrogen:helium=3:7) as adsorption gas with a surface area analyzer for pore distribution measurement (for example, FlowSorb III 2310, Shimadzu Corporation). Then, the specific surface area is obtained according to the BET one-point method from the amount of nitrogen adsorption when the relative pressure P/P₀ is 0.3. To calculate the specific surface area, the automatic calculation software of the measurement apparatus may be used.

A ratio of the specific surface area of water vapor adsorption to the specific surface area of nitrogen adsorption (the specific surface area of water vapor adsorption/the specific surface area of nitrogen adsorption) may be 0.048 or less, 0.042 or less, preferably 0.035 or less, more preferably 0.030 or less, and still more preferably 0.025 or less.

The ratio of the specific surface area of water vapor adsorption to the specific surface area of nitrogen adsorption is preferably 0.005 or more, more preferably 0.007 or more, and still more preferably 0.010 or more.

A smaller ratio of the specific surface area of water vapor adsorption to the specific surface area of nitrogen adsorption suggests that there are many fine recesses and projections on the surface of carbonaceous particles, fine recesses and projections that allow nitrogen molecules to enter but not water molecules, or that water molecules cannot come into contact with the hydroxyl groups existing in the recesses due to the shape of the recesses on the surface of the carbonaceous particles, and as a result, the water molecules are less likely to be adsorbed. Such carbonaceous particles can be obtained by, for example, activating core particles as carbon particles by heat treatment or the like so as to obtain core particles having a specific surface shape, and then surface-coating the surface of the activated core particles at least partially with a carbon substance B having a lower crystallinity than the core particles. However, the carbonaceous particles in the present invention are not limited to such a shape, composition, and production method.

Examples of carbonaceous particles (it means core particles in a case in which the particles are surface-coated at least partially) include artificial graphite particles, natural graphite particles, graphitized mesophase carbon particles, low crystalline carbon particles, amorphous carbon particles, and mesophase carbon particles.

From the viewpoint of increasing charge and discharge capacities, the carbonaceous particles preferably contain graphite particles. The shape of the graphite particles is not particularly limited, and examples thereof include scale-like, spherical, massive, and fibrous shapes. From the viewpoint of obtaining a high tap density, it is preferably spherical.

The artificial graphite particles may be, for example, graphite particles in which a plurality of flat particles are aggregated or bonded such that the orientation planes (main planes) are non-parallel (hereinafter, referred to as “massive graphite particles”). Whether or not massive graphite particles are contained can be confirmed by observation with a scanning electron microscope (SEM).

Flat particles are particles having a major axis and a minor axis and are not completely spherical. For example, particles having shapes such as scaly, scale-like, and massive shapes are included. In the massive graphite particles, when the main surfaces of the plurality of flat particles are non-parallel, it means that the surfaces (main surfaces) having the largest cross-sectional areas of the flat graphite particles are not aligned in a certain direction.

Further, in the massive graphite particles, the flat particles are aggregated or bonded, and the “bond” refers to a state in which the particles are chemically bonded to each other through carbonaceous substances in which organic binders such as tar and pitch are carbonized. In addition, the term “aggregate” refers to a state in which particles are not chemically bonded to each other, and the shape of the aggregate is maintained due to its shape or the like. From the viewpoint of mechanical strength, it is preferable that the flat particles are bonded.

In one massive graphite particle, the number of flat particles aggregated or bonded is not particularly limited, but it is preferably 3 or more, more preferably from 5 to 20, and still more preferably from 5 to 15.

The method of producing massive graphite particles is not particularly limited as long as a predetermined configuration is formed. For example, massive graphite particles can be obtained by adding a graphitization catalyst to a graphitizable skeletal material or a mixture of graphite and a graphitizable binder (organic binder), further mixing, firing, and then pulverizing. As a result, pores are generated after the graphitization catalyst is removed, and favorable characteristics are imparted as massive graphite particles. Further, the massive graphite particles can be adjusted to a desired configuration by selecting, if appropriate, a method of mixing graphite or a skeletal material and a binder, adjustment of a mixing ratio such as the amount of binder, pulverization conditions after firing, and the like.

As the graphitizable skeletal material, for example, a coke powder, a carbide of resin, or the like can be used, but there is no particular limitation as long as it is a graphitizable powder material. Of these, coke powder that is easily graphitized, such as needle coke, is preferable. The graphite is not particularly limited as long as it is in the powder form, and natural graphite powder, artificial graphite powder, and the like can be used. The volume average particle size of the graphitizable skeletal material or graphite is preferably smaller than the volume average particle size of the massive graphite particles, and more preferably ⅔ or less of the volume average particle size of the massive graphite particles. Further, the graphitizable skeletal material or graphite is preferably in a form of flat particles.

In a case in which the graphitizable skeletal material or graphite is in a form of flat particles, spherical graphite particles such as spherical natural graphite may be used in combination.

As the graphitization catalyst, for example, metals or metalloids such as iron, nickel, titanium, silicon, and boron, carbides thereof, oxides thereof, and the like can be used. Of these, carbides or oxides of silicon or boron are preferable. The amount of such a graphitization catalyst added is preferably from 1% by mass to 50% by mass, more preferably from 5% by mass to 40% by mass, and still more preferably from 5% by mass to 30% by mass with respect to the obtained massive graphite particles.

The binder (organic binder) is not particularly limited as long as it can be graphitized by firing, and examples thereof include organic materials such as tar, pitch, a thermosetting resin, and a thermoplastic resin. Further, the binder is preferably added in an amount of from 5% by mass to 80% by mass, more preferably from 10% by mass to 80% by mass, and still more preferably from 15% by mass to 80% by mass with respect to the flat graphitizable skeletal material or graphite.

The method of mixing the graphitizable skeletal material or graphite and the binder is not particularly limited, and mixing is preferably performed using a kneader or the like, and at a temperature equal to or higher than the softening point of the binder. Specifically, the mixing temperature is preferably from 50° C. to 300° C. in a case in which the binder is pitch, tar or the like, and from 20° C. to 100° C. in a case in which the binder is a thermosetting resin, a thermoplastic resin or the like.

The above mixture is fired to be graphitized, thereby obtaining massive graphite particles. The mixture may be formed into a predetermined shape before graphitization. Further, after molding, it may be pulverized before graphitization so as to adjust the particle size, and then graphitization may be performed.

Firing is preferably performed under conditions in which the mixture is difficult to oxidize, and examples thereof include a method of firing in a nitrogen atmosphere or an argon gas atmosphere, or in vacuum. The graphitization temperature is preferably 2000° C. or higher, more preferably 2500° C. or higher, and still more preferably from 2800° C. to 3200° C.

In a case in which the particle size is not adjusted before graphitization, it is preferable to pulverize the graphitized product obtained by graphitization so as to yield a desired volume average particle size. The method of pulverizing the graphitized product is not particularly limited, but known methods such as jet milling, vibration milling, pin milling, and hammer milling can be used. After carrying out the above production method, graphite particles, in which a plurality of flat particles are aggregated or bonded such that their main surfaces are non-parallel, namely, massive graphite particles can be obtained.

Further, for details of the method of producing massive graphite particles, for example, Japanese Patent Nos. 3285520 and 3325021 can be referred to.

The carbonaceous particles may be formed by providing a carbonaceous substance B having a lower crystallinity than a carbonaceous substance A on at least a part of the surface of the carbonaceous substance A (which may constitute core particles). As the carbonaceous particles are surface-coated at least partially with the carbonaceous substance B having a low crystallinity, the reactivity with the electrolyte solution on the surface of the carbon particles is reduced. Thus, the input characteristics tend to be improved while the initial charge-discharge efficiencies are favorably maintained.

Whether or not a carbonaceous substance B having a low crystallinity is present on the surface of the carbonaceous particles can be determined based on the observation results by a transmission electron microscope (TEM). Hereinafter, carbonaceous particles that are surface-coated at least partially with a carbonaceous substance B having a low crystallinity are also referred to as “coated carbonaceous particles.”

Examples of the carbonaceous substance B include carbon materials such as low crystalline carbon, amorphous carbon, and mesophase carbon, and preferably include amorphous carbon.

A content of the carbonaceous substance B in the coated carbonaceous particles is not particularly limited. From the viewpoint of improving the input characteristics, the content of the carbonaceous substance B is preferably 0.1% by mass or more, more preferably 0.5% by mass or more, and still more preferably 1% by mass or more with respect to a total amount of the coated carbonaceous particles. From the viewpoint of suppressing the decrease in capacity, the content of the carbonaceous substance B is preferably 30% by mass or less, more preferably 20% by mass or less, and still more preferably 10% by mass or less.

The content of the carbonaceous substance B can be determined by the following method.

The coated carbonaceous particles are heated at a heating rate of 15° C./minute, and the mass is measured in a range of from 30° C. to 950° C. The mass reduction at from 30° C. to 700° C. is defined as the mass of the carbonaceous substance B. The content of the carbonaceous substance B is calculated by the following formula using the mass of the carbonaceous substance B.

Content of carbonaceous substance B (% by mass)=(mass of carbonaceous substance B/mass of coated carbonaceous particles at 30° C.)×100

An average thickness of the carbonaceous substance B in the coated carbonaceous particles is preferably 1 nm or more, more preferably 2 nm or more, and still more preferably 3 nm or more from the viewpoint of initial charge-discharge efficiencies and input characteristics.

Further, the average thickness of the carbonaceous substance B in the coated carbonaceous particles is preferably 500 nm or less, more preferably 300 nm or less, and still more preferably 100 nm or less from the viewpoint of energy density.

The average thickness of the carbonaceous substance B in the coated carbonaceous particles is a value obtained by measuring at arbitrary 20 points with a transmission electron microscope and obtaining the arithmetic mean thereof.

A volume average particle size (D₅₀) of the carbonaceous particles (in the case of coated carbonaceous particles, it means carbonaceous particles coated) is preferably from 2 μm to 50 more preferably from 5 μm to 35 and still more preferably from 7 μm to 30 μm. When the volume average particle size of the carbonaceous particles is 50 μm or less, the discharge capacity and the discharge characteristics tend to be improved. When the volume average particle size of the carbonaceous particles is 2 μm or more, the initial charge-discharge efficiencies tend to be improved.

The volume average particle size (D₅₀) is determined as D₅₀ (median size) by measuring the volume-based particle size distribution using a laser diffraction particle size analyzer for particle size distribution measurement (for example, SALD-3000J, Shimadzu Corporation).

A particle size distribution (D90/D10) of the carbonaceous particles (in the case of coated carbonaceous particles, it means carbonaceous particles coated) is preferably 2.00 or less, more preferably 1.90 or less, and still more preferably 1.85 or less.

The particle size distribution (D90/D10) is determined by obtaining the particle size having a cumulative volume percentage of 10% (D10) from the small diameter side and the particle size having a cumulative volume percentage of 90% (D90) from the small diameter side in the volume-based particle size distribution obtained by the above measurement of the volume average particle size (D50) and calculating the ratio thereof (D90/D10).

The average circularity of carbonaceous particles (in the case of coated carbonaceous particles, it means carbonaceous particles coated) is preferably 0.85 or more, more preferably 0.88 or more, and still more preferably 0.90 or more.

The circularity of carbonaceous particles is a value obtained by dividing the peripheral length of a circle calculated from the equivalent circle diameter, which is the diameter of a circle having the same area as the projected area of carbonaceous particles by the peripheral length (contour line length) measured from the projected image of carbonaceous particles, which is calculated by the following formula. The circularity is 1.00 in a perfect circle.

Circularity=(peripheral length of equivalent circle)/(peripheral length of particle cross-sectional image)

Specifically, the average circularity of carbonaceous particles is measured using a wet-flow type particle size and shape analyzer (for example, FPIA-3000, Malvern Panalytical Ltd.). The measurement temperature was 25° C., the concentration of a measurement sample is 10% by mass, and the number of particles to be counted is 12000. In addition, water is used as a dispersion solvent.

When measuring the circularity of carbonaceous particles, it is preferable to disperse the carbonaceous particles in water in advance. For example, it is possible to disperse carbonaceous particles in water using an ultrasonic dispersion, a vortex mixer, or the like. In order to suppress the influence of particle decay or particle destruction of carbonaceous particles, the intensity and time of ultrasonic waves may be adjusted, if appropriate, in consideration of the intensity of the carbonaceous particles to be measured.

For ultrasonic treatment, for example, it is preferable that after filling a tank of an ultrasonic cleaner (ASU-10D, AS ONE Corporation) with an arbitrary amount of water, a test tube containing a dispersion of carbonaceous particles is immersed in the water inside the tank together with a test tube holder, followed by ultrasonic treatment for from 1 to 10 minutes. Within this treatment time, it becomes easy to disperse carbonaceous particles while suppressing particle decay, particle destruction, an increase in the sample temperature, and the like of carbonaceous particles.

For the carbonaceous particles, an R value measured by Raman spectrometry is preferably 0.30 or less, more preferably 0.28 or less, still more preferably 0.26 or less, particularly preferably 0.25 or less, and extremely preferably 0.24 or less.

The R value is the ratio of the peak intensity I₁₃₅₀ of the second peak P2 showing the maximum intensity in a wavenumber range of from 1350 cm⁻¹ to 1370 cm⁻¹ with respect to the peak intensity I₁₅₈₀ of the first peak P1 showing the maximum intensity in a wavenumber range of from 1580 cm⁻¹ to 1620 cm⁻¹ (I₁₃₅₀/I₁₅₈₀) in Raman spectrum analysis using green laser light having a wavelength of 532 nm. Here, the first peak P1 appearing in the wavenumber range of from 1580 cm⁻¹ to 1620 cm⁻¹ is usually a peak identified to correspond to the graphite crystal structure. The second peak P2 appearing in the wavenumber range of from 1350 cm⁻¹ to 1370 cm⁻¹ is usually a peak identified to correspond to the amorphous structure of carbon.

[Measurement of R Value]

Raman spectrometry is carried out hereunder using a laser Raman spectrophotometer (Model number: NRS-1000, JASCO Corporation), by irradiating a sample plate of a negative electrode material for a lithium ion secondary battery set flatwise with a semiconductor laser light. The measurement conditions are as follows.

Wavelength of semiconductor laser light: 532 nm

Wavenumber resolution: 2.56 cm⁻¹

Measurement range: from 850 cm⁻¹ to 1950 cm⁻¹

Peak research: background removal

<Method of Producing Negative Electrode Material for Lithium Ion Secondary Battery>

The method of producing a negative electrode material for a lithium ion secondary battery in the disclosure is not particularly limited, and examples thereof include the following method. One example of the method of producing a negative electrode material for a lithium ion secondary battery in the disclosure is a production method including: preparing activated carbonaceous substance particles A obtained by heat-treating particles of a carbonaceous substance A; mixing a carbonaceous substance precursor that is a source of a carbonaceous substance B having a lower crystallinity than the carbonaceous substance A, and the activated carbonaceous substance particles A, to obtain a mixture; and heat-treating the mixture, to obtain carbonaceous particles.

The method of producing a negative electrode material for a lithium ion secondary battery in the disclosure may include other processes, if necessary.

<Preparing Activated Carbonaceous Substance Particles A>

In preparing activated carbonaceous substance particles A, activated carbonaceous substance particles A obtained by heat-treating particles of a carbonaceous substance A are prepared. Examples of the heat treatment include heat treatment in an atmosphere in which CO₂ gas, water vapor, O₂ gas, and the like are present. From the viewpoint of controlling the particle size of the activated carbonaceous substance particles A, controlling the surface state of the activated carbonaceous substance particles A, or the like, it is preferable to perform heat treatment in an atmosphere in which O₂ gas is present (for example, in an air atmosphere).

The heat treatment temperature is preferably adjusted, if appropriate according to the gas atmosphere used, the treatment time, and the like. For example, in the case of treatment in an air atmosphere, the heat treatment temperature is preferably from 100° C. to 800° C., more preferably from 150° C. to 750° C., and still more preferably from 350° C. to 750° C. Within this temperature range, it is possible to increase the specific surface area of the activated carbonaceous substance particles A without burning the carbonaceous substance A.

In addition, the heat treatment time in an air atmosphere is preferably adjusted, if appropriate according to the heat treatment temperature, the type of carbon material, and the like, for example, it is preferably from 0.5 hours to 24 hours, and more preferably from 1 hour to 6 hours. Within this time, it is possible to effectively increase the specific surface area of the activated carbonaceous substance particles A. Further, in a case in which the heat treatment is performed in an atmosphere in which O₂ gas is present, a content of O₂ gas is preferably from 1% by volume to 30% by volume. Within this range, the specific surface area of the activated carbonaceous substance particles A tends to be effectively increased.

A heat treatment temperature in a CO₂ gas atmosphere is preferably from 600° C. to 1200° C., and more preferably from 700° C. to 1100° C. In addition, the heat treatment time in a CO₂ gas atmosphere is preferably adjusted, if appropriate according to the heat treatment temperature, the type of carbon material, and the like, for example, it is preferably from 0.5 hours to 24 hours, and more preferably from 1 hour to 6 hours.

The specific surface area of water vapor adsorption of carbonaceous particles increases as the heat treatment temperature for activation increases, while on the other hand, it tends to decrease when the temperature exceeds a specific temperature. Similarly, the specific surface area of nitrogen adsorption of carbonaceous particles also increases as the heat treatment temperature for activation increases, while on the other hand, it tends to decrease when the temperature exceeds a specific temperature. In the heat treatment for activation, the reason why the specific surface area of carbonaceous particles changes from increase to decrease at a specific temperature is not clear, but it can be considered as follows. Up to a certain temperature, the carbonaceous particles tend to be activated so as to form fine pores on the surface. When the temperature reaches to a specific temperature or higher, it is considered that some of the fine pores formed on the surface are connected to cause a decrease in the specific surface area. This particular temperature is often different between the case of the specific surface area of water vapor adsorption and the case of the specific surface area of nitrogen adsorption.

The carbonaceous substance A used in preparing the activated carbonaceous substance particles A is not particularly limited, and examples thereof include those described as the core particles of the carbonaceous particles described above.

In a case in which the carbonaceous substance A is spherical natural graphite, a volume average particle size (D₅₀) of the carbonaceous substance A is preferably from 2 μm to 30 μm, more preferably from 5 μm to 25 μm, and still more preferably from 7 μm to 20 μm.

In a case in which the carbonaceous substance A is artificial graphite, a volume average particle size (D₅₀) of the carbonaceous substance A is preferably from 8 μm to 40 μm, more preferably from 10 μm to 35 μm, and still more preferably 12 μm to 30 μm.

In a case in which the carbonaceous substance A is spherical natural graphite, a BET specific surface area of the carbonaceous substance A is preferably from 4 m²/g to 15 m²/g, more preferably from 5 m²/g to 15 m²/g, still more preferably from 6 m²/g to 13 m²/g, and particularly preferably from 7 m²/g to 11 m²/g.

In a case in which the carbonaceous substance A is artificial graphite, a BET specific surface area of the carbonaceous substance A is preferably from 0.5 m²/g to 10 m²/g, more preferably from 1 m²/g to 10 m²/g, still more preferably from 2 m²/g to 8 m²/g, and particularly preferably from 3 m²/g to 7 m²/g.

In a case in which the carbonaceous substance A is spherical natural graphite, a BET specific surface area of the activated carbonaceous substance particles A is preferably from 5 m²/g to 23 m²/g, more preferably from 6 m²/g to 20 m²/g, and still more preferably from 7 m²/g to 15 m²/g.

In a case in which the carbonaceous substance A is artificial graphite, a BET specific surface area of the activated carbonaceous substance particles A is preferably from 1 m²/g to 13 m²/g, more preferably from 2 m²/g to 12 m²/g, and still more preferably 3 m²/g to 10 m²/g.

In the method of producing a negative electrode material for a lithium ion secondary battery in the disclosure, commercially available activated carbonaceous substance particles A can also be purchased and prepared.

<Obtaining Mixture>

In obtaining a mixture, a carbonaceous substance precursor, which is a source of a carbonaceous substance B having a lower crystallinity than the carbonaceous substance A, and the activated carbonaceous substance particles A are mixed.

From the viewpoint of improving the input characteristics, the carbonaceous substance B preferably contains at least one of crystalline carbon and amorphous carbon. For example, the carbonaceous substance B is preferably a carbonaceous substance obtained from an organic compound that can be converted into a carbonaceous substance by heat treatment. Hereinafter, the carbonaceous substance precursor that is the source of the carbonaceous substance B is also referred to as a precursor of carbonaceous substance B. Specific examples of the carbonaceous substance B include those similar to the examples mentioned as the carbonic substance B in the above-described carbonaceous particles.

The precursor of carbonaceous substance B is not particularly limited, and examples thereof include pitch and organic polymer compounds. Examples of pitch include ethylene heavy end pitch, crude oil pitch, coal tar pitch, asphalt decomposition pitch, pitch produced by thermal decomposition of polyvinyl chloride, and pitch produced by polymerizing naphthalene and the like in the presence of super strong acid.

Examples of organic polymer compounds include thermoplastic resins such as polyvinyl chloride, polyvinyl alcohol, polyvinyl acetate, and polyvinyl butyral, and natural substances such as starch and cellulose.

In a case in which pitch is used as the precursor of carbonaceous substance B, the softening point of pitch is preferably from 70° C. to 250° C., more preferably from 75° C. to 150° C., and still more preferably from 80° C. to 120° C.

The softening point of pitch refers to a value obtained by the softening point measuring method (ring-ball method) of tar pitch described in JIS K 2425: 2006.

A residual carbon content of the precursor of carbonaceous substance B is preferably from 5% by mass to 80% by mass, more preferably from 10% by mass to 70% by mass, and still more preferably from 20% by mass to 60% by mass.

The residual carbon content of the precursor of carbonaceous substance B can be determined by heat-treating the precursor of carbonaceous substance B alone (or in the state of a mixture of the precursor of carbonaceous substance B and the activated carbonaceous substance particles A in a predetermined ratio) at a temperature that can convert the precursor of carbonaceous substance B into a carbonaceous substance and performing a calculation based on a mass of the precursor of carbonaceous substance B before the heat treatment and a mass of the carbonic substance B derived from the precursor of carbonaceous substance B after the heat treatment. The mass of the precursor of carbonaceous substance B before the heat treatment and the mass of the carbonic substance B derived from the precursor of carbonaceous substance B after the heat treatment can be determined by thermogravimetric analysis or the like.

If necessary, the mixture may contain other particulate carbonaceous substance B (carbonaceous particles) in addition to the precursor of carbonaceous substance B. In a case in which the mixture contains carbonaceous particles together with the precursor of carbonaceous substance B, the carbonaceous particles and the carbonaceous substance B formed from the precursor of carbonaceous substance B may be the same or different.

Carbonaceous particles used as the other carbonaceous substance B are not particularly limited, and examples thereof include particles of acetylene black, oil furnace black, Ketjen black, channel black, thermal black, and earthy graphite.

In obtaining a mixture, each content of the activated carbonaceous substance particles A and the precursor of carbonaceous substance B in the mixture are not particularly limited. From the viewpoint of input characteristics, a content of the precursor of carbonaceous substance B is an amount such that the content of the carbonaceous substance B in the total mass of the negative electrode material for a lithium ion secondary battery is 0.1% by mass or more, more preferably 0.5% by mass or more, and still more preferably 1% by mass or more. From the viewpoint of suppressing the decrease in capacity, the content of the precursor of carbonaceous substance B is such that the content of the carbonaceous substance B in the total mass of the negative electrode material for a lithium ion secondary battery is preferably 30% by mass or less, more preferably 20% by mass or less, and still more preferably 10% by mass or less.

In obtaining a mixture, the method of preparing a mixture containing the activated carbonaceous substance particles A and the precursor of carbonaceous substance B is not particularly limited. Examples thereof include a method of removing a solvent after mixing activated carbonaceous substance particles A and a precursor of carbonaceous substance B with the solvent (wet mixing), a method of mixing activated carbonaceous substance particles A and a precursor of carbonaceous substance B in a powder state (powder mixing), and a method of mixing activated carbonaceous substance particles A and a precursor of carbonaceous substance B while applying mechanical energy (mechanical mixing).

The mixture containing the activated carbonaceous substance particles A and the precursor of carbonaceous substance B is preferably in a complexed state. The complexed state means that the respective materials are in physical or chemical contact.

<Obtaining Carbonaceous Particles>

In obtaining carbonaceous particles, the mixture is heat-treated, thereby obtaining carbonaceous particles. In the obtained carbonaceous particles, the carbonaceous substance B is provided on at least a part of the surface of the activated carbonaceous substance particles A.

A heat treatment temperature when heating-treating the mixture is not particularly limited. For example, the heat treatment is preferably performed under a temperature condition of from 700° C. to 1500° C., more preferably performed under a temperature condition of from 750° C. to 1300° C., and still more preferably performed under a temperature condition of from 800° C. to 1200° C. From the viewpoint of sufficiently advancing the carbonization of the precursor of carbonaceous substance B, the heat treatment is preferably performed under a temperature condition of 700° C. or higher, and from the viewpoint of improving the input characteristics, the heat treatment is preferably performed at a temperature of 1500° C. or lower. As long as the heat treatment temperature is within the above range, the initial charge-discharge efficiencies and the input characteristics tend to be improved. The heat treatment temperature may be constant or may change from the start to the end of the heat treatment.

A treatment time for heat-treating the mixture varies depending on the type of the precursor of carbonaceous substance B used. For example, in a case in which coal tar pitch having a softening point of 100° C. (±20° C.) is used as the precursor of carbonaceous substance B, the temperature is preferably raised to 400° C. at a rate of 10° C./minute or less. A total heat treatment time including the raising temperature process is preferably from 2 hours to 18 hours, more preferably from 3 hours to 15 hours, and still more preferably from 4 hours to 12 hours.

An atmosphere when heat-treating the mixture is not particularly limited as long as it is an inert gas atmosphere such as nitrogen gas or argon gas, and a nitrogen gas atmosphere is preferable from the industrial viewpoint.

Obtaining carbonaceous particles is preferably setting the specific surface area of water vapor adsorption of the carbonaceous particles within the above range. Further, obtaining carbonaceous particles is preferably setting the specific surface area of nitrogen adsorption of the nitrogen adsorption particles within the above range.

The specific surface area of water vapor adsorption and the specific surface area of nitrogen adsorption of the carbonaceous particles refer to the specific surface area of water vapor adsorption and the specific surface area of nitrogen adsorption of the carbonaceous particles after crushing described later.

A crystallinity of the carbonaceous substance B is lower than a crystallinity of the activated carbonaceous substance particles A. Since the crystallinity of the carbonaceous substance B is lower than the crystallinity of the activated carbonaceous substance particles A, the input characteristics tend to be improved.

The levels of crystallinity of the activated carbonaceous substance particles A and the carbonaceous substance B can be determined based on, for example, observation results by a transmission electron microscope (TEM).

The carbonaceous particles obtained in obtaining carbonaceous particles may be crushed by a cutter mill, a feather mill, a juicer mixer, or the like. The crushed carbonaceous particles may be sieved.

<Negative electrode for Lithium Ion Secondary Battery>

A negative electrode for a lithium ion secondary battery in the disclosure includes: a negative electrode material layer containing the negative electrode material for a lithium ion secondary battery in the disclosure described above; and a current collector. If necessary, the negative electrode for a lithium ion secondary battery may contain other components, in addition to the current collector and the negative electrode material layer containing the negative electrode material in the disclosure.

The negative electrode for a lithium ion secondary battery can be produced by, for example: kneading the negative electrode material for a lithium ion secondary battery and a binder, along with a solvent, to prepare a negative electrode material composition for a lithium ion secondary battery in a form of a slurry; and coating the resulting composition on a current collector to form the negative electrode material layer, or forming the negative electrode material composition for a lithium ion secondary battery in a form of a sheet, pellets, or the like, followed by integrating the resultant with a current collector. The kneading can be carried out using a dispersing apparatus such as an agitator, a ball mill, a super sand mill, or a pressure kneader.

The binder to be used for preparing the negative electrode material composition for a lithium ion secondary is not particularly limited. Examples of the binder include: an ethylenically unsaturated carboxylic acid ester, such as a styrene-butadiene copolymer (SBR), methyl acrylate, methyl methacrylate, ethyl acrylate, ethyl methacrylate, butyl acrylate, butyl methacrylate, hydroxyethyl acrylate, and hydroxyethyl methacrylate; and homopolymer or copolymer of an ethylenically unsaturated carboxylic acid, such as acrylic acid, methacrylic acid, itaconic acid, fumaric acid, and maleic acid; and a high molecular weight compound having a high ion conductivity, such as polyvinylidene fluoride, polyethylene oxide, polyepichlorohydrin, polyphosphazene, and polyacrylonitrile, polymethacrylonitrile. In a case in which the negative electrode material composition for a lithium ion secondary contains the binder, an amount of the binder is not particularly limited. For example, the amount of the binder may be from 0.5 parts by mass to 20 parts by mass with respect to 100 parts by mass of the total amount of the negative electrode material for a lithium ion secondary and the binder.

The negative electrode material composition for a lithium ion secondary may contain a thickener. As the thickener, it is possible to use, for example, carboxymethyl cellulose, methyl cellulose, hydroxymethyl cellulose, ethyl cellulose, polyvinyl alcohol, polyacrylic acid or a salt thereof, oxidized starch, phosphorylated starch, casein, or the like. In a case in which the negative electrode material composition for a lithium ion secondary contains the thickener, an amount of the thickener is not particularly limited. For example, the amount of the thickener may be from 0.1 parts by mass to 5 parts by mass with respect to 100 parts by mass of the amount of the negative electrode material for a lithium ion secondary.

The negative electrode material composition for a lithium ion secondary may contain a conductive auxiliary material. Examples of the conductive auxiliary material include: a carbon material, such as carbon black, graphite, and acetylene black; and an inorganic compound, such as an oxide and a nitride which exhibit electric conductivity. In a case in which the negative electrode material composition for a lithium ion secondary contains the conductive auxiliary material, an amount of the conductive auxiliary material is not particularly limited. For example, the amount of the conductive auxiliary material may be from 0.5 parts by mass to 15 parts by mass with respect to 100 parts by mass of the amount of the negative electrode material for a lithium ion secondary.

Materials for the current collector are not particularly limited, and can be selected from the group consisting of aluminum, copper, nickel, titanium, stainless steel, and the like. A form of the current collector is not particularly limited, and the current collector may be in a form of a foil, a perforated foil, a mesh, or the like. Further, a porous material such as a porous metal (expanded metal), a carbon paper, or the like can also be used as the current collector.

In a case in which the negative electrode material composition for a lithium ion secondary is coated on the current collector to form the negative electrode material layer, a method therefor is not particularly limited, and it is possible to use a known method, such as, for example, a metal mask printing method, an electrostatic spray painting method, a dip coating method, a spray coating method, a roll coating method, a doctor blade method, a comma coating method, a gravure coating method, or a screen printing method. After coating the negative electrode material composition for a lithium ion secondary on the current collector, the solvent contained in the negative electrode material composition for a lithium ion secondary is removed by drying. The drying can be carried out, for example, using a hot air dryer, an infrared dryer, or a combination of these apparatuses. If necessary, a rolling processing of the negative electrode material layer may be carried out. The rolling processing can be carried out by a method using a flat plate press, a calender roll, or the like.

In a case in which the negative electrode composition for a lithium ion secondary formed in the form of a sheet, pellets, or the like, is integrated with the current collector to form the negative electrode material layer, a method of integration is not particularly limited. For example, the integration can be carried out using a roll, a flat plate press, or by a combination of these means. It is preferable that the pressure to be applied during the integration of the negative electrode composition for a lithium ion secondary with the current is, for example, from about 1 MPa to 200 MPa.

A negative electrode density of the negative electrode material is not particularly limited. For example, the negative electrode density is preferably from 1.1 g/cm³ to 1.8 g/cm³, more preferably from 1.1 g/cm³ to 1.7 g/cm³, and still more preferably from 1.1 g/cm³ to 1.6 g/cm³. When the negative electrode density is adjusted to 1.1 g/cm³ or more, an increase in electronic resistance tends to be prevented to result in an increased capacity. When the negative electrode density is adjusted to 1.8 g/cm³ or less, decreases in input-output characteristics and cycle characteristics tend to be prevented.

<Lithium Ion Secondary Battery>

A lithium ion secondary battery in the disclosure includes: the negative electrode for a lithium ion secondary battery; a positive electrode; and an electrolyte solution.

The positive electrode can be obtained in the same manner as the method of preparing the negative electrode described above, by forming a positive electrode layer on a current collector. As the current collector, it is possible to use a metal or an alloy such as aluminum, titanium or stainless steel, formed in a form of a foil, a perforated foil, a mesh, or the like.

A positive electrode material used for forming the positive electrode layer is not particularly limited. Examples of the positive electrode material include a metal compound (such as a metal oxide and a metal sulfide) capable of doping or intercalating lithium ions, and an electrically conductive polymer material. More specific examples thereof include: a metal compound, such as lithium cobaltate (LiCoO₂), lithium nickelate (LiNiO₂), lithium manganate (LiMnO₂), a complex oxide thereof (LiCoₓNi_{y}Mn_{z}O₂, in which x+y+z=1), a complex oxide containing an added element M′ (LiCoₐNi_{b}Mn_{c}M′_{d}O₂, in which a+b+c+d=1, M′: Al, Mg, Ti, Zr or Ge), a spinel-type lithium manganese oxide (LiMn₂O₄), a lithium vanadium compound, V₂O₅, V₆O₁₃, VO₂, MnO₂, TiO₂, MoV₂O₈, TiS₂, V₂S₅, VS₂, MoS₂, MoS₃, Cr₃O₈, Cr₂O₅, and olivine-type LiMPO₄ (M: Co, Ni, Mn, Fe); an electrically conductive polymer, such as polyacetylene, polyaniline, polypyrrole, polythiophene, and polyacene; and a porous carbon. The positive electrode material may be used singly, or in a combination of two or more kinds thereof.

The electrolyte solution is not particularly limited, and it is possible to use, for example, one obtained by dissolving a lithium salt as an electrolyte in a non-aqueous solvent (so-called an organic electrolyte solution).

Examples of the lithium salt include LiClO₄, LiPF₆, LiAsF₆, LiBF₄, and LiSO₃CF₃. The lithium salt may be used singly, or in a combination of two or more kinds thereof.

Examples of the non-aqueous solvent include ethylene carbonate, fluoroethylene carbonate, chloroethylene carbonate, propylene carbonate, butylene carbonate, vinylene carbonate, cyclopentanone, cyclohexylbenzene, sulfolane, propane sultone, 3-methylsulfolane, 2,4-dimethylsulfolane, 3-methyl-1,3-oxazolidin-2-one, γ-butyrolactone, dimethyl carbonate, diethyl carbonate, ethyl methyl carbonate, methylpropyl carbonate, butylmethyl carbonate, ethylpropyl carbonate, butylethyl carbonate, dipropyl carbonate, 1,2-dimethoxyethane, tetrahydrofuran, 2-methyltetrahydrofuran, 1,3-dioxolane, methyl acetate, ethyl acetate, trimethyl phosphate, and triethyl phosphate. The non-aqueous solvent may be used singly, or in a combination of two or more kinds thereof.

Forms of the positive electrode and the negative electrode in the lithium ion secondary battery are not particularly limited. For example, the positive electrode and the negative electrode, and if necessary, a separator disposed between the positive electrode and the negative electrode, may be wound in a form of a helix, or these components may be formed in the form of flat plates and layered one on another.

The separator is not particularly limited, and it is possible to use, for example, a nonwoven fabric made of a resin, a cloth, a microporous film, or a combination thereof. Examples of the resin include a resin containing, as a main component, a polyolefin, such as polyethylene or polypropylene. In a case in which the lithium ion secondary battery to be formed has a structure in which the positive electrode and the negative electrode are not directly in contact with each other, a separator is not necessarily used.

A form of the lithium ion secondary battery is not particularly limited. The lithium ion secondary battery may be, for example, a laminate-type battery, a paper-type battery, a button-type battery, a coin-type battery, a layered battery, a cylindrical battery, or a prismatic battery.

The lithium ion secondary battery in the disclosure is appropriate as a high capacity lithium ion secondary battery to be used in an electric vehicle, a power tool, a power storage apparatus, or the like, because of its excellent in input characteristics, high temperature storage characteristics and initial charge-discharge efficiencies. In particular, the lithium ion secondary battery in the disclosure is appropriate as a lithium ion secondary battery to be used in an electric vehicle (EV), a hybrid electric vehicle (HEV), a plug-in hybrid electric vehicle (PHEV) or the like, for which a capability to be charged and discharged at a high current is demanded in order to improve acceleration performance and brake regeneration performance.

### EXAMPLES

The present invention will now be more specifically described by way of Examples. However, the present invention is in no way limited to the following Examples.

### Example 1

[Preparation of Negative Electrode Material]

Spherical natural graphite in an amount of 60 g (volume average particle size: 10 μm) as graphite particles was placed in an alumina crucible having a volume of 0.864 L, and allowed to stand for 1 hour in an air atmosphere at 400° C. for heat treatment.

A mixture was obtained by powder mixing of 100 parts by mass of the heat-treated graphite particles with 8.0 parts by mass of coal-tar pitch (softening point: 98° C., residual coal rate: 50% by mass). Next, the mixture was heat-treated, thereby preparing a fired product having amorphous carbon adhering to the surface thereof. The heat treatment was carried out by increasing the temperature from 25° C. to 1000° C. at a temperature increase rate of 200° C./hour under nitrogen flow and maintaining the temperature at 1000° C. for 1 hour. The fired product obtained as a negative electrode material having amorphous carbon adhering to the surface thereof in Example 1 was crushed with a cutter mill and sieved with a 350-mesh sieve. The portion under the sieve was designated as a negative electrode material for a lithium ion secondary battery (negative electrode material).

### Example 2

A negative electrode material was prepared in the same manner as in Example 1, except that the heat treatment temperature for the graphite particles was changed to 500° C., and the amount of the coal-tar pitch was changed to 6.4 parts by mass.

### Example 3

A negative electrode material was prepared in the same manner as in Example 2, except that the amount of the coal-tar pitch was changed to 7.5 parts by mass.

### Examples 4 and 5

A negative electrode material was prepared in the same manner as in Example 1, except that the heat treatment temperature of 400° C. for the graphite particles was changed to the temperature shown in Table 1.

### Example 6

A negative electrode material was prepared in the same manner as in Example 1, except that the graphite particles was changed to that having a volume average particle size (D₅₀) of 17 μm, and the heat treatment temperature for the graphite particles was changed to 500° C.

### Comparative Example 1

The graphite particles used as the crude material in Example 1 were used directly as a negative electrode material without heat treatment.

### Comparative Example 2

A negative electrode material was prepared in the same manner as in Example 1, except that the graphite particles used as the crude material in Example 1 was not heat-treatmented, and then amorphous carbon was allowed to adhere to the surface of the graphite particles.

### Comparative Example 3

A negative electrode material was prepared in the same manner as in Example 1, except that the heat treatment temperature for the graphite particles was changed to 500° C. in a nitrogen atmosphere.

### Comparative Example 4

A negative electrode material was prepared in the same manner as in Example 1, except that the heat treatment temperature for the graphite particles was changed to 300° C.

### Comparative Example 5

A negative electrode material was prepared in the same manner as in Example 1, except that the graphite particles was changed to that having a volume average particle size (D₅₀) of 17 μm, and the heat treatment temperature for the graphite particles was changed to 300° C.

### Comparative Example 6

A negative electrode material was prepared in the same manner as in Example 1, except that the graphite particles was changed to that having a volume average particle size (D₅₀) of 17 μm, the heat treatment temperature for the graphite particles was changed to 650° C., and the processing time of the heat treatment was changed to 15 minutes.

### Comparative Example 7

A negative electrode material was prepared in the same manner as in Example 1, except that the graphite particles was changed to that having a volume average particle size (D₅₀) of 17 μm, the heat treatment temperature for the graphite particles was changed to 650° C., the processing time of the heat treatment was changed to 15 minutes, and the coal-tar pitch of 8.0 parts by mass changed to a petroleum-based tar of 14 parts by mass.

The following measurements were performed on the obtained negative electrode materials of Examples 1 to 6 and Comparative Examples 1 to 7.

[Measurement of Specific Surface Area of Water Vapor Adsorption]

An amount of water vapor adsorption was measured when the adsorption temperature was determined to 298 K and the relative pressure P/P₀ was varied from 0.0000 to 0.9500 in a constant temperature bath set at 50° C. using saturated steam gas with a “high-precision gas/vapor adsorption analyzer BELSORP MAX” (BEL JAPAN, INC.). The specific surface area of water vapor adsorption was determined according to the BET multipoint method from the amount of water vapor adsorption when the relative pressure P/P₀ was in a range of from 0.05 to 0.12.

As a pretreatment for measurement, a measurement cell charged with 0.05 g of a negative electrode material was decompressed to 10 Pa or less with a vacuum pump, heated at 110° C., retained for 3 hours or more, and then was naturally cooled to room temperature (25° C.) while being kept in a decompressed state.

[Measurement of Specific Surface Area of Nitrogen Adsorption]

A specific surface area of nitrogen adsorption was calculated according to the BET method by measuring nitrogen adsorption at a liquid nitrogen temperature (77K) by the one-point method with a relative pressure of 0.3 using a mixed gas of nitrogen and helium (nitrogen:helium=3:7) as the adsorption gas with a surface area analyzer for pore distribution measurement (FlowSorb III 2310, Shimadzu Corporation).

As a pretreatment for measurement, a measurement cell charged with 0.05 g of a negative electrode material was decompressed to 10 Pa or less with a vacuum pump, heated at 110° C., retained for 3 hours or more, and then was naturally cooled to room temperature (25° C.) while being kept in a decompressed state.

[Measurement of Volume Average Particle Size (D50)]

A dispersion liquid, in which the negative electrode material was dispersed in purified water together with a surfactant, was placed in a sample water tank of a laser diffraction particle size analyzer for particle size distribution measurement (SALD-3000J, Shimadzu Corporation). Next, the particle size distribution was obtained by circulating the dispersion liquid by a pump while applying ultrasound thereto, thereby obtaining a particle size distribution. The particle size having a cumulative volume percentage of 50% in the particle size distribution was determined as the volume average particle size.

[Measurement of Particle Size Distribution (D90/D10)]

In the particle size distribution obtained by the above measurement of the volume average particle size (D50), a particle size having a cumulative volume percentage of 10% (D10) from the small diameter side and a particle size having a cumulative volume percentage of 90% (D90) from the small diameter side were obtained, and the ratio thereof (D90/D10) was calculated.

[Measurement of Average Circularity]

A 10% by mass aqueous dispersion was prepared by adding the negative electrode material to water, thereby obtaining a measurement sample. A test tube containing the measurement sample was placed together with a test tube holder in water contained in a tank of an ultrasonic cleaner (ASU-10D, AS ONE Corporation). Then, ultrasonic treatment was performed for from 1 minute to 10 minutes.

After the ultrasonic treatment, the average circularity of the graphite particles was measured at 25° C. using a wet-flow type particle size and shape analyzer (FPIA-3000, Malvern Panalytical Ltd.). The number of particles to be counted was 12000.

[Measurement of R Value]

A Raman spectrometry was carried out hereunder using a laser Raman spectrophotometer (Model number: NRS-1000, JASCO Corporation), by irradiating a sample plate of a negative electrode material for a lithium ion secondary battery set flatwise with a semiconductor laser light. The measurement conditions are as follows.

Wavelength of semiconductor laser light: 532 nm

Wavenumber resolution: 2.56 cm⁻¹

Measurement range: from 850 cm⁻¹ to 1950 cm⁻¹

Peak research: background removal

[Measurement of Coating Layer Thickness]

A thickness of the carbonaceous substance B having low crystallinity on the particle surface was measured at arbitrary 20 points with a transmission electron microscope, and the arithmetic mean thereof was calculated.

TABLE 1

| | | | | Specific | Specific | | | | | | |
|---|---|---|---|---|---|---|---|---|---|---|---|
| | | | | Surface | Surface | | | | | | |
| | | | | Area of | Area of | | Average | Particle | | | Average |
| | Heat Treatment | | | Water Vapor | Nitrogen | | Particle | Size | | | Thickness |
| | Temperature | Atmosphere | | Adsorption | Adsorption | | Size (D50) | Distribution | Average | R | of Coating |
| | (° C.) | Gas | Coating | (A) | (B) | A/B | (μm) | (D90/D10) | Circularity | Value | Layer (nm) |
| Example 1 | 400 | air | coated | 0.075 | 3.5 | 0.021 | 10 | 1.83 | 0.92 | 0.28 | 20 |
| Example 2 | 500 | air | coated | 0.074 | 5.5 | 0.013 | 10 | 1.82 | 0.93 | 0.25 | 12 |
| Example 3 | 500 | air | coated | 0.074 | 4.5 | 0.016 | 10 | 1.83 | 0.93 | 0.23 | 15 |
| Example 4 | 600 | air | coated | 0.074 | 4.5 | 0.016 | 10 | 1.79 | 0.94 | 0.22 | 18 |
| Example 5 | 700 | air | coated | 0.094 | 3.7 | 0.025 | 10 | 1.75 | 0.94 | 0.19 | 16 |
| Example 6 | 500 | air | coated | 0.072 | 4.5 | 0.016 | 17 | 1.74 | 0.94 | 0.21 | 15 |
| Comparative | — | — | uncoated | 0.360 | 9.5 | 0.038 | 10 | 1.78 | 0.94 | 0.27 | not |
| Example 1 | | | | | | | | | | | observed |
| Comparative | — | — | coated | 0.097 | 4.3 | 0.023 | 10 | 1.82 | 0.93 | 0.31 | 18 |
| Example 2 | | | | | | | | | | | |
| Comparative | 500 | nitrogen | coated | 0.096 | 4.3 | 0.022 | 10 | 1.83 | 0.93 | 0.31 | 19 |
| Example 3 | | | | | | | | | | | |
| Comparative | 300 | air | coated | 0.096 | 4.3 | 0.022 | 10 | 1.82 | 0.93 | 0.28 | 17 |
| Example 4 | | | | | | | | | | | |
| Comparative | 300 | air | coated | 0.096 | 3.5 | 0.027 | 17 | 1.83 | 0.93 | 0.29 | 18 |
| Example 5 | | | | | | | | | | | |
| Comparative | 650 | air | coated | 0.096 | 3.5 | 0.027 | 17 | 1.75 | 0.94 | 0.27 | 18 |
| Example 6 | | | | | | | | | | | |
| Comparative | 650 | air | coated | 0.096 | 3.0 | 0.032 | 17 | 1.74 | 0.94 | 0.27 | 24 |
| Example 7 | | | | | | | | | | | |

[Preparation of Positive Electrode]

(LiNi_{1/3}Mn_{1/3}Co_{1/3}O₂) (BET specific surface area: 0.4 m²/g, average particle size (d50): 6.5 μm) was used as a positive electrode active material. Acetylene black (trade name: HS-100, average particle size: 48 nm (Denka Company's catalog value), manufactured by Denka Company) as a conductive material and polyvinylidene fluoride as a binder were sequentially added to this positive electrode active material, and mixed, thereby obtaining a mixture of a positive electrode material. The mass ratio was set to positive electrode active material:conductive material:binder=80:13:7. Further, N-methyl-2-pyrrolidone (NMP) as a dispersion solvent was added to the above mixture and kneaded, thereby forming a slurry. This slurry was applied to both sides of aluminum foil having an average thickness of 20 which is a current collector for a positive electrode, substantially evenly and uniformly. Then, drying was carried out, followed by compression by pressing, thereby yielding a density of 2.7 g/cm³.

[Preparation of Negative Electrode]

The negative electrode materials shown in Table 1 were each used as a negative electrode active material.

Carboxymethyl cellulose (CMC) was added as a thickener and styrene-butadiene rubber (SBR) was added as a binder to this negative electrode active material. The mass ratio thereof was set to negative electrode active material:CMC:SBR=98:1:1. Purified water, which is a dispersion solvent, was added thereto and kneaded, thereby forming a slurry of each of the Examples and the Comparative Examples. A given amount of each slurry was applied to both sides of rolled copper foil having an average thickness of 10 which is a current collector for a negative electrode, substantially evenly and uniformly. A density of the negative electrode material layer was 1.2 g/cm³.

[Preparation of Lithium Ion Secondary Battery] (Single Pole)

Each prepared negative electrode was punched into a disk shape having a diameter of 14 mm, thereby preparing a sample electrode (negative electrode).

The prepared sample electrode (negative electrode), a separator, and a counter electrode (positive electrode) were placed in a coin-type battery container in this order, and an electrolyte solution was injected thereinto, thereby preparing a coin-type lithium ion secondary battery. The electrolyte solution used was a mixture of ethylene carbonate (EC) and ethyl methyl carbonate (EMC) (volume ratio of EC and EMC was 3:7), in which LiPF₆ was dissolved at a concentration of 1.0 mol/L. Metallic lithium was used as a counter electrode (positive electrode). As the separator, a polyethylene micropore membrane having a thickness of 20 μm was used. The initial charge-discharge efficiencies were evaluated by the following method using the prepared lithium ion secondary battery.

[Evaluation of Initial Charge-Discharge Efficiencies]

(1) Charging was carried out, at a constant current of 0.48 mA (equivalence of 0.2 CA), to 0 V (V vs. Li/Li⁺). Subsequently, charging was carried out, at a constant voltage of 0 V (V vs. Li/Li⁺), to a current value of 0.048 mA. The capacity at this time was taken as an initial charge capacity.

(2) After 30 minutes of downtime, discharging was carried out, at a constant current of 0.48 mA, to 1.5 V (V vs. Li/Li⁺). The capacity at this time was taken as an initial discharge capacity.

(3) The initial charge-discharge efficiency was determined from the charge and discharge capacities obtained in the above described (1) and (2), according to the following Formula 1.

Initial charge-discharge efficiency (%)={(initial discharge capacity)/(initial charge capacity)}×100 (Formula 1)

[Preparation of Lithium Ion Secondary Battery]

The prepared positive and negative electrodes were each cut to a predetermined size, and the cut positive electrode and the negative electrode, between which a polyethylene single-layer separator (trade name: Hipore, Asahi Kasei Corporation, “Hypore” is a registered trademark) having an average thickness of 30 μm was sandwiched, were wound, thereby forming a rolled electrode body. At such time, the lengths of the positive electrode, the negative electrode, and the separator were adjusted such that the diameter of the electrode body was 17.15 mm. A current collection lead was attached to this electrode body, the electrode body was inserted into an 18650-type battery case, and then a non-aqueous electrolyte solution was injected into the battery case. The non-aqueous electrolyte used was prepared by dissolving lithium hexafluorophosphate (LiPF₆) as a lithium salt (electrolyte) at a concentration of 1.2 mol/L in a mixed solvent in which ethylene carbonate (EC), which is a cyclic carbonate, and dimethyl carbonate (DMC) and ethyl methyl carbonate (EMC), which are chain carbonates, were mixed in a volume ratio of 2:3:2, to which 1.0% by mass of vinylene carbonate (VC) was added. Finally, the battery case was sealed, thereby completing a lithium ion secondary battery.

[Initial State]

The prepared lithium ion secondary battery was charged with a constant current to 4.2 V at a current value equivalent to 0.5 CA in an environment of 25° C., and from the time when the current value reached 4.2 V, the lithium ion secondary battery was charged with a constant voltage until the current value reached a current value equivalent to 0.01 CA at that voltage. Then, it was discharged with a constant current to 2.7 V at a current value equivalent to 0.5 CA for discharge. This was carried out for three cycles. A 30-minute break was provided between cycles of charge and discharge. The lithium ion secondary battery after three cycles is designated as being in the initial state. The discharge capacity in the third cycle is defined as “discharge capacity 1.”

[High Temperature Storage Characteristics]

The battery in the initial state was charged with a constant current to 4.2 V at a current value equivalent to 0.5 CA in an environment of 25° C., and from the time when the current value reached 4.2 V, the lithium ion secondary battery was charged with a constant voltage until the current value reached a current value equivalent to 0.01 CA at that voltage. Then, it was allowed to stand for 90 days in an environment of 60° C. The battery that had been allowed to stand was left in an environment of 25° C. for 6 hours, and then discharged to 2.7 V at a current value equivalent to 0.5 CA. Subsequently, the battery was charged with a constant current to 4.2 V at a current value equivalent to 0.5 CA, and from the time when the current value reached 4.2 V, the lithium ion secondary battery was charged with a constant voltage until the current value reached a value equivalent to 0.01 CA at that voltage. Then it was discharged with a constant current to 2.7 V at a current value equivalent to 0.5 CA for discharge. The discharge capacity at such time is defined as “discharge capacity 2.” A 30-minute break was provided between cycles of charge and discharge. From the discharge capacity 1 and the discharge capacity 2 obtained above, the high temperature storage characteristics were obtained using the following Formula 2.

High temperature storage characteristics (%)=(discharge capacity 2/discharge capacity 1)×100 (Formula 2)

[Evaluation of Input Characteristics]

The battery in the initial state was allowed to stand in a constant temperature bath set to an environmental temperature of 25° C. such that the temperature inside the battery and the environmental temperature were equal to each other, and then the battery was charged at a current value equivalent to 0.5 CA for 11 seconds. Subsequently, it was discharged to 2.7 V at a current value equivalent to 0.5 CA. Similarly, an initial resistance was obtained by changing the charging current value equivalent to 1 CA, 3 CA, and 5 CA and calculating the slope from the relationship between the voltage change and the current value. The input characteristics were evaluated from the value of this initial resistance.

TABLE 2

| | | | Input |
|---|---|---|---|
| | Initial | | Characteristics |
| | Charge-discharge | High Temperature | (Initial |
| | Efficiencies | Storage | Resistance) |
| | (%) | Characteristics(%) | (mΩ) |
| Example 1 | 94.2 | 89.3 | 54 |
| Example 2 | 93.5 | 85.6 | 51 |
| Example 3 | 93.9 | 88.4 | 52 |
| Example 4 | 93.8 | 88.4 | 52 |
| Example 5 | 93.6 | 86.5 | 53 |
| Example 6 | 94.5 | 90.2 | 56 |
| Comparative | 90.9 | 79.1 | 72 |
| Example 1 | | | |
| Comparative | 93.7 | 86.5 | 63 |
| Example 2 | | | |
| Comparative | 94.5 | 88.3 | 67 |
| Example 3 | | | |
| Comparative | 93.8 | 86.5 | 62 |
| Example 4 | | | |
| Comparative | 93.5 | 84.6 | 61 |
| Example 5 | | | |
| Comparative | 93.8 | 87.8 | 62 |
| Example 6 | | | |
| Comparative | 93.7 | 87.2 | 63 |
| Example 7 | | | |

As shown in Table 2, it is found that the lithium ion secondary batteries prepared using the negative electrode materials of Examples have excellent input characteristics, maintaining high temperature storage characteristics and initial charge-discharge efficiencies, as compared to the lithium ion secondary batteries prepared using the negative electrode materials of Comparative Examples.

1. A negative electrode material for a lithium ion secondary battery, the negative electrode material comprising carbonaceous particles having a BET specific surface area of water vapor adsorption of 0.095 m²/g or less calculated from an amount of water vapor adsorption at a relative pressure of from 0.05 to 0.12.

2. The negative electrode material for a lithium ion secondary battery according to claim 1, wherein, in the carbonaceous particles, a ratio of the BET specific surface area of water vapor adsorption to a BET specific surface area of nitrogen adsorption calculated from an amount of nitrogen adsorption at a relative pressure of 0.3 is 0.035 or less.

3. The negative electrode material for a lithium ion secondary battery according to claim 1, wherein the carbonaceous particles have a carbonaceous substance B on at least a part of a surface of a carbonaceous substance A, and the carbonaceous substance B has a lower crystallinity than the carbonaceous substance A.

4. The negative electrode material for a lithium ion secondary battery according to claim 3, wherein an average thickness of the carbonaceous substance B is 1 nm or more.

5. The negative electrode material for a lithium ion secondary battery according to claim 3, wherein a content of the carbonaceous substance B is 30% by mass or less with respect to a total amount of the carbonaceous particles.

6. The negative electrode material for a lithium ion secondary battery according to claim 1, wherein a volume average particle size of the carbonaceous particles is from 2 μm to 50 μm.

7. The negative electrode material for a lithium ion secondary battery according to claim 1, wherein an R value of Raman spectrometry is 0.30 or less.

8. A method of producing the negative electrode material for a lithium ion secondary battery according to claim 1, the method comprising:
preparing activated carbonaceous substance particles A obtained by heat-treating particles of a carbonaceous substance A;
mixing a carbonaceous substance precursor that is a source of a carbonaceous substance B having a lower crystallinity than the carbonaceous substance A, and the activated carbonaceous substance particles A, to obtain a mixture; and
heat-treating the mixture, to obtain carbonaceous particles.

9. A negative electrode for a lithium ion secondary battery, the negative electrode comprising:
a negative electrode material layer containing the negative electrode material for a lithium ion secondary battery according to claim 1; and
a current collector.

10. A lithium ion secondary battery, comprising:
the negative electrode for a lithium ion secondary battery according to claim 9;
a positive electrode; and
an electrolyte solution.
